(19) United States
(12) Patent Application Publication
(10) Pub. No.: US 2007/0061701 A1
(43) Pub. Date: Mar. 15, 2007

(54) Input suggestions based on prior business process consequences

(75) Inventors: Gil Thieberger, Kiryat Tivon (IL); Michal Rosenfeld, Haifa (IL); Michael Karasik, Jerusalem (IL)

Correspondence Address: Active Knowledge Ltd., POB 294, Kiryat Tivon, 36010, IL

(73) Assignee: Active Knowledge Ltd., Kiryat Tivon (IL)

(21) Appl. No.: 11/520,019

(22) Filed: Sep. 13, 2006

Related U.S. Application Data
(60) Provisional application No. 60/716,490, filed on Sep. 14, 2005.

(51) Int. Cl. G06F 17/30; G06F 17/00

(52) U.S. Cl. 715/507; 707/5

(57) ABSTRACT

A computer implemented method for providing input suggestions based on prior business process consequences, including the steps of receiving an input to an entry field in the business process instance, wherein the input is not predetermined at entry time, identifying a consequence of the business process instance, and associating the input with metadata based on the identified consequence, wherein the identified consequence of the business process instance is not predetermined when the input is received.

### CROSS-REFERENCE TO RELATED APPLICATIONS

This application claims the benefit of U.S. Provisional Patent Application Ser. No. 60/716,490, filed on 14 Sep. 2005, which is incorporated herein by reference.

### FIELD OF THE INVENTION

The embodiments of the present invention relate to software and, more particularly, to methods for providing input suggestions based on prior business process consequences.

### BACKGROUND

Workflow, business process, and electronic data entry based systems allow an enterprise to formalize the processes by which the enterprise achieves its business objectives. Such systems provide step-by-step descriptions of tasks which should be performed as part of the work, so that individuals or groups within the enterprise can be assigned individual or groups of tasks. The tasks may be dependent or independent upon one another.

### BRIEF SUMMARY

The embodiments of the present invention relate to software and, more particularly, to methods for providing input suggestions based on prior business process consequences.

Implementation of the embodiments of the present invention involves performing or completing selected tasks or steps manually, semi-automatically, fully automatically, and/or a combination thereof. Moreover, depending upon actual instrumentation and/or equipment used for implementing an embodiment of the disclosed methods, several embodiments could be achieved by hardware, by software, by firmware, or a combination thereof.

### BRIEF DESCRIPTION OF THE DRAWINGS

The embodiments of the present invention are herein described, by way of example only, with reference to the accompanying drawings. With specific reference now to the drawings, it is stressed that the particulars shown are by way of example and for purposes of illustrative discussion of the embodiments of the present invention only, and are presented in order to provide what is believed to be the most useful and readily understood description of the principles and conceptual aspects of the embodiments of the present invention. In this regard, no attempt is made to show structural details of the embodiments in more detail than is necessary for a fundamental understanding of the invention. The description taken with the drawings makes apparent to those skilled in the art how the several embodiments may be embodied in practice. Identical structures, elements or parts which appear in more than one figure are preferably labeled with a same or similar number in all the figures in which they appear. In the drawings:

FIGS. 1A-1B are schematic illustrations of a screen display showing a business process instance wherein a form is filled with exemplary input in accordance with an embodiment of the present invention.

FIGS. 1C-1D are schematic illustrations of exemplary metadata associated with the exemplary input illustrated in FIG. 1A.

FIGS. 2A-2B are schematic illustrations of a screen display showing interaction of a user with a suggestion box, in accordance with an embodiment of the present invention.

FIGS. 3A-3D are block diagrams of exemplary input repositories, in accordance with an embodiment of the present invention.

FIG. 4A is a flowchart illustrating the process steps of associating input with metadata according to an embodiment of the present invention.

FIG. 4B is a flowchart illustrating the process steps of mapping business process events to corresponding inputs according to an embodiment of the present invention.

FIG. 5 is a flowchart illustrating the process steps of providing a user with data following the user's input according to an embodiment of the present invention.

FIG. 6 is a flowchart illustrating the process steps of providing a user with data following the user's interaction with an entry field according to an embodiment of the present invention.

FIG. 7 is a flowchart illustrating the process steps of providing a user with data following the user's interaction with an entry field according to another embodiment of the present invention.

FIG. 8 is a flowchart illustrating the process steps of predicting a consequence of a business process instance following a user's input according to an embodiment of the present invention.

FIGS. 9A-9B are flowcharts illustrating the process steps of providing a user with input suggestions following the user's interaction with an entry field according to an embodiment of the present invention.

FIG. 10 is a flowchart illustrating the process steps of providing a user with data following the user's input according to an embodiment of the present invention.

FIG. 11 is a flowchart illustrating the process steps of providing a user with input suggestions following the user's interaction with an entry field according to an embodiment of the present invention.

### DETAILED DESCRIPTION

In the following description, numerous specific details are provided to provide a thorough understanding of embodiments of the invention. One skilled in the relevant art, however, will recognize that the embodiments may be practiced without one or more of these specific details, or with other equivalent elements and components, etc. In other instances, well-known components and elements are not shown, or not described in detail, to avoid obscuring aspects of the invention or for brevity.

The following disclosure provides a brief, general description of a suitable computing environment in which the embodiments of the present invention may be implemented. Those skilled in the relevant art will appreciate that the embodiments may be practiced with other computer system configurations, including hand-held devices, multiprocessor systems, microprocessor-based or programmable consumer electronics, network PCs, network computers, mini computers, mainframe computers, and the like. The embodiments may be practiced in distributed computing environments where tasks or modules are performed by remote processing devices, which are linked through a communications network. In a distributed computing environment, program modules may be located in both local and remote memory storage devices. The embodiments may be practiced in hardware, programmable devices, and other equivalents.

The term “business process” as used herein may also refer to a workflow, an e-learning process, and/or to a software wizard process.

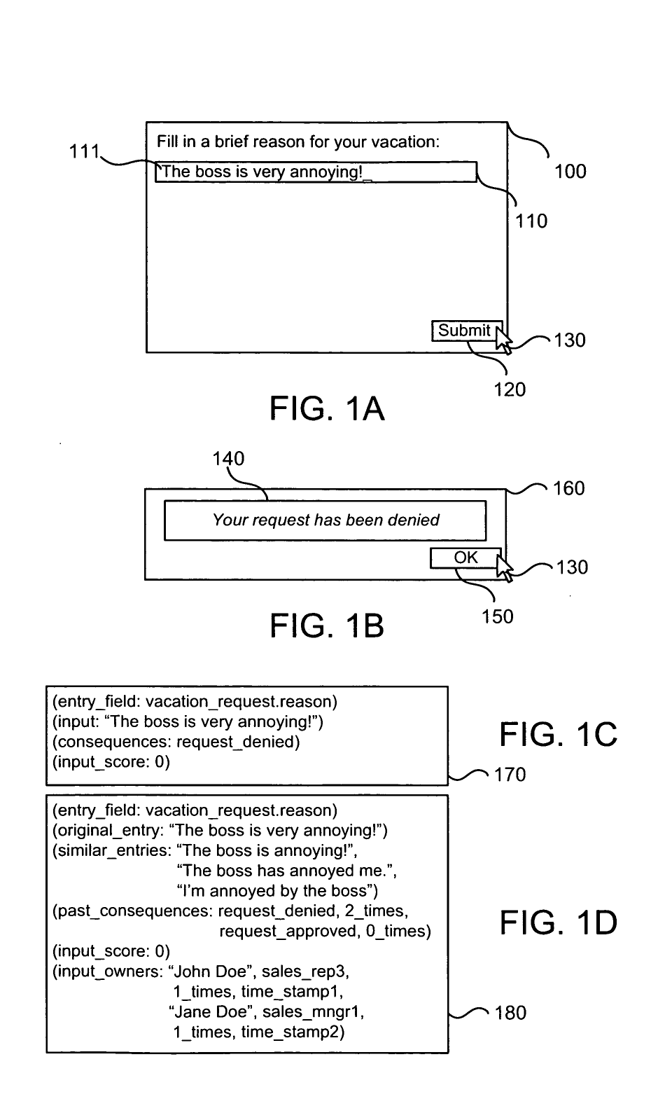

Referring now to the drawings, FIG. 1A illustrates a form of a business process instance 100, an entry field 110, a cursor 130, and a button 120 for submitting the form. As illustrated, a user has entered the input 111 to the entry field 110. The user may further submit the form. FIG. 1B illustrates a screen display 160 following the form submission. As illustrated, a notice 140 may notify the user of a negative consequence of the business process instance and a button 150 may be provided for subsequent user interaction.

In an embodiment of the present invention, the input 111 that resulted in the negative consequence may be associated with metadata describing the negative consequence and may be stored in a repository. This is further illustrated by FIGS. 1C-1D. FIG. 1C illustrates exemplary metadata 170 that may be associated with the input entered by the user. The metadata 170 may be transferred into a repository wherein it may be analyzed and combined with previous data. FIG. ID illustrates exemplary metadata 180 which may result from such a combination and may be stored in the repository.

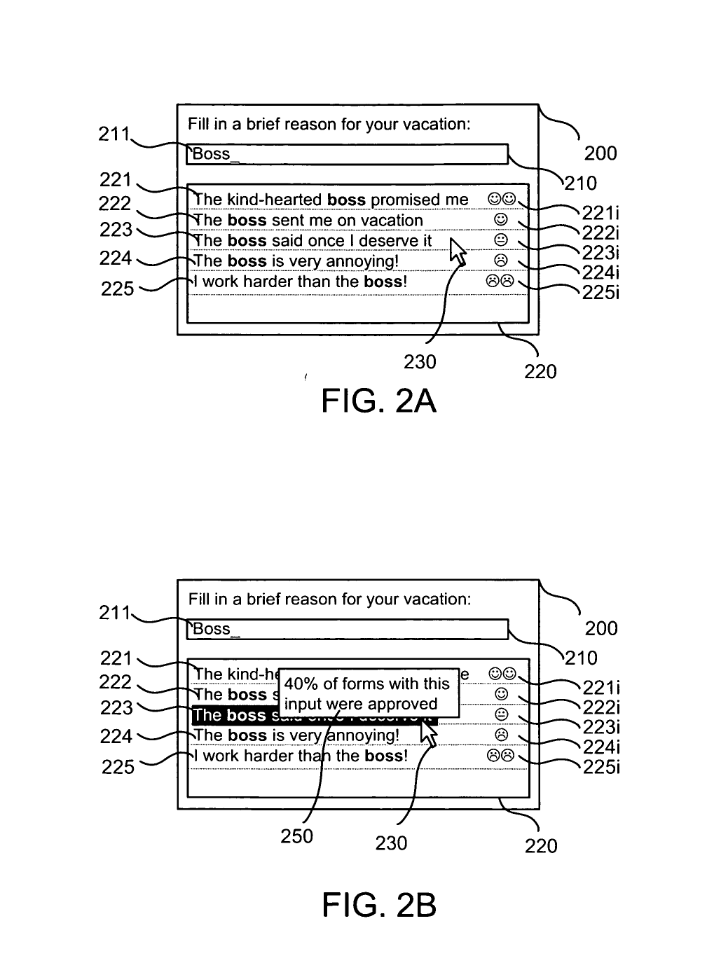

FIGS. 2A-2B illustrate an embodiment of the invention including a form of a business process instance 200, an entry field 210, a suggestion box 220, and a cursor 230. As illustrated in FIG. 2A, the entry field 210 was filled with partial user input 211. The user has entered the word ‘Boss’. Triggered by the input, the suggestion box 220 may become populated with suggestions 221-225. Each suggestion may have an icon associated with it 221i-225i; the icons may depict a score associated with each suggestion. The suggestions may be sorted by their associated score. As illustrated in FIG. 2B, when the user moves the cursor 230 over a suggestion 223, a tooltip 250, a pop-up window (not shown in the drawing), or an equivalent, may appear, providing additional data for this specific input suggestion.

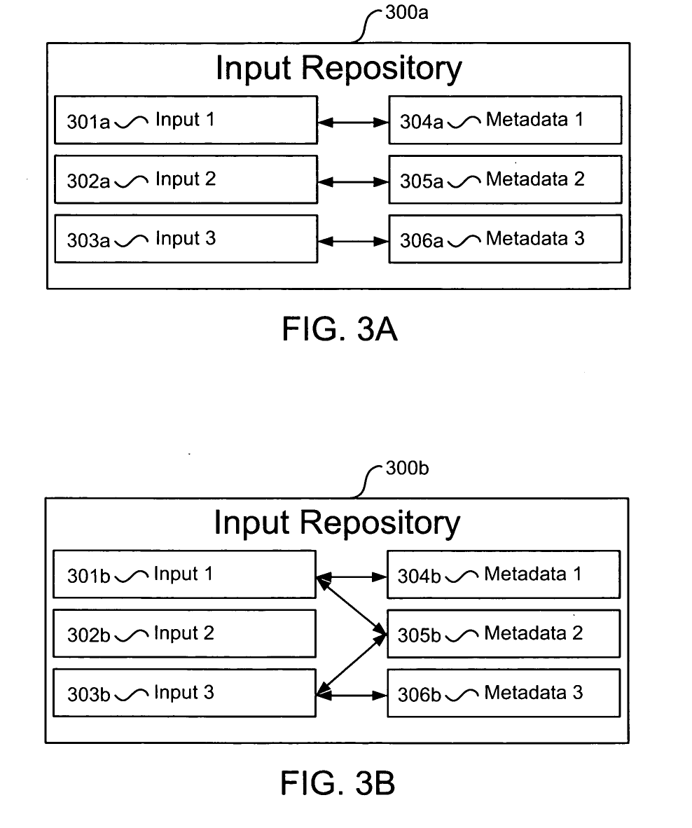

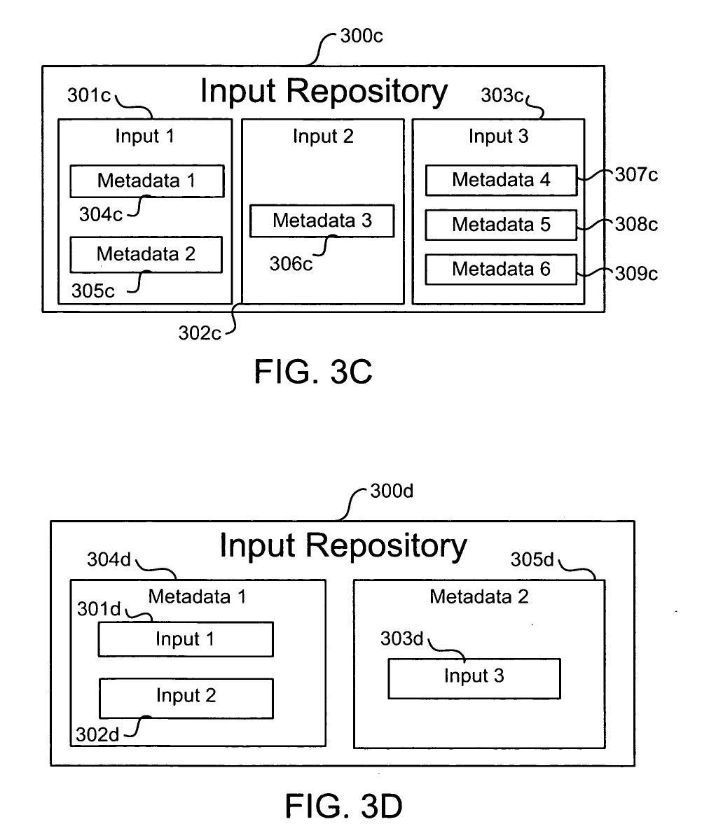

FIGS. 3A-3D illustrate exemplary structures of a repository capable of containing multiple inputs, metadata and associations thereof, in accordance with the present invention.

FIG. 3A illustrates an exemplary repository 300a comprising inputs 301a-303a, and metadata 304a-306a. There may be a one-to-one correspondence between inputs and metadata. For example, each input may have its own metadata describing a consequence of the input in a business process instance wherein the input was entered.

FIG. 3B illustrates another exemplary repository 300b comprising inputs 301b-303b, and metadata 304b-306b. An input may be associated with multiple metadata and metadata may have any number of inputs associated with it. For example, a business process may have multiple consequences described by the metadata. The inputs may have metadata associated to them according to each consequence of a business process instance. Furthermore, the inputs may comprise a counter for every business process consequence, according to the number of times that the consequence was generated by the input.

FIG. 3C illustrates another exemplary repository 300c comprising inputs 301c-303c, and metadata 304c-309c. Each input may be associated with its own collection of metadata. For example, the collection of metadata may include metadata describing consequences of business process instances wherein the input was used, metadata about users who entered these inputs, time of entry, a generated score for the input, equivalent inputs, etc. Furthermore, metadata may be arranged hierarchically. For example, metadata regarding a user who entered the input may further comprise a collection of metadata regarding this user's role, active project, expertise, experience, etc.

FIG. 3D illustrates another exemplary repository 300d comprising inputs 301d-303d, and predefined metadata 304d-305d. For example, predefined metadata may be a set of possible consequences of a business process. Each predefined metadata may have multiple inputs associated with it. For example, the repository may contain two kinds of metadata; one corresponding to a positive consequence of a business process and the other to a negative consequence. Inputs in such a repository may be associated with the corresponding metadata based on a consequence of a business process instance wherein the input is provided. Furthermore, inputs may be grouped by common criteria, such as: inputs entered in the same entry field, semantically equivalent inputs, inputs entered by users with similar properties, etc.

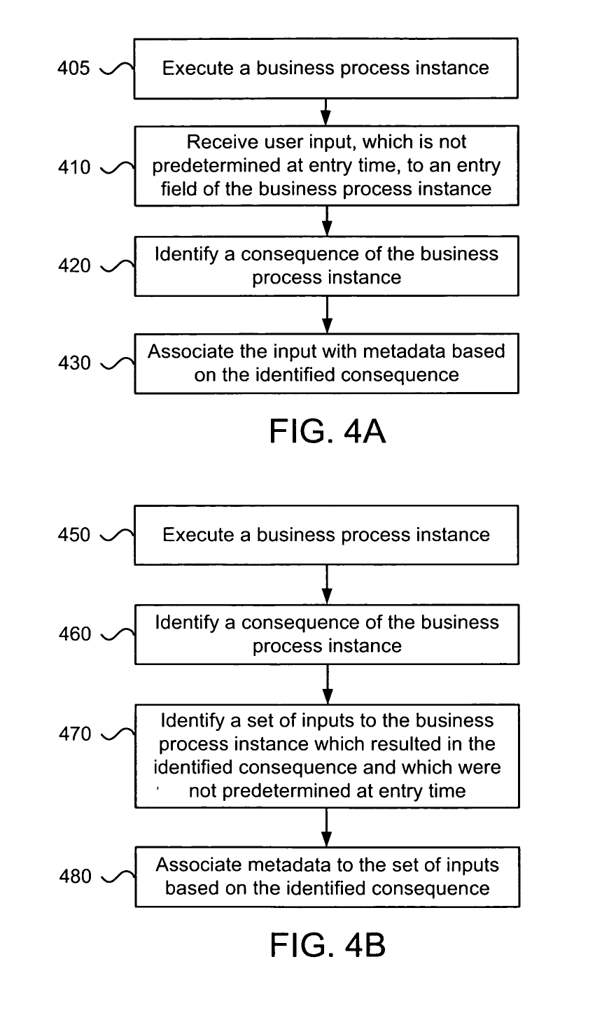

FIG. 4A illustrates an embodiment of the invention. First, a business process instance is executed in step 405. This may be, for example, an instance of a business process for a vacation request. At some point during the execution of the business process instance, an input for an entry field of the business process instance is received in step 410. These are inputs which were not predetermined at their entry time, i.e. inputs which required human consideration.

An input may be predetermined at entry time, for example, by the context of the business process instance, such as by various related inputs and variables. An input determined by a user's private considerations is not considered predetermined. A predetermined input may be an input whose value must be specific and the only correct possible value at entry time. This value may be received or calculated by a user entering the input. A non-predefined input may be a value provided by a user to an entry field, wherein more than one equally possible values could be provided. An input of a patient's temperature, which a nurse measured beforehand by using a thermometer, is an example of a predefined input, since there is no human consideration only a mechanistic action. An input of a number of days a user wants as vacation is an example of a non-predetermined input which requires human consideration and wherein there is no single correct value.

In an embodiment of the invention, an entry field may be, for example, a text box, a drop-down list, a checkbox, a radio button, an entire electronic form, a combination thereof, or any other data receptacle capable of receiving input. The input may be received by using a mouse, a keyboard, a voice recognition device, a communication link, a combination thereof, any other device capable of generating input for the entry field, or without using a device at all.

In step 420, a consequence of the business process instance is identified. The consequence may occur at any point during and/or after the execution of the business process instance. This consequence may be any event that directly or indirectly relates to the business process instance.

In an embodiment of the invention, this event may be a direct result of the aforementioned input. For example, the input may be a numerical value describing a desired processing mode of a factory machine and the event may be an auto-generated report concerning the daily productivity of the machine running in this mode. The event may be an indirect result of the business process. For example, the input may be a choice of an advertisement design and the event may be a report of a net profit by a company.

The event may also comprise a modification of the input, or its replacement. For example, if a user enters some input into an entry field, and at some point later realizes that the input is wrong and rewrites it, the act of rewriting the input may be regarded as such an event. If the business process instance was an instance of a vacation request business process, a possible consequence may be an approval or denial of the request.

Once an input is received and a consequence is identified, metadata concerning the consequence is generated and associated with the input in step 430. An input may have associated metadata concerning more than one consequence. Not all consequences necessarily trigger metadata generation for every input preceding these consequences. In an embodiment of the invention, specific predefined business process consequences may trigger metadata for specific predefined preceding inputs. The exact configuration thereof may be defined, for example, at design-time by a designer of the business process.

The consequence of the business process instance may be a direct result of the input or an indirect result of the input. In the case where the consequence is an indirect result of the input, the association between the input and the consequence may be defined, for example, by an operator, a software module that searches for associations, and/or a heuristic algorithm. For example, when the entry field is a request description, and as a result of the business process execution the request description was changed, the change in the request description is considered a consequence of the business process.

In an embodiment of the invention, metadata associated with the input may comprise a certain scoring of the input. For example, if the business process instance is concerned with providing help to customers in a call center and the identified consequence is a positive feedback by a customer, the input causing such a consequence may receive a positive score.

The aforementioned consequence may be identified by receiving data from a source other than the business process instance itself. For example, the source may be an instance of another business process, such as one that is concerned with drawing feedback from customers. An input may have more than one score associated with it, and these scores may have varying weights. In an embodiment of the invention, a score given with regard to a direct consequence has more weight than a score given with regard to an indirect consequence.

Metadata associated with the input may comprise a description of the identified consequence. For example, if the business process instance is a request which may be either approved or denied, the metadata may comprise a boolean value representing these possible consequences.

Optionally, the more an identified consequence is a direct result of its corresponding input, the higher the score assigned to the corresponding input.

Optionally, the consequence may be identified by a user and entered manually to the system. Alternatively, the consequence may be identified by using an appropriate web service. The web service may be in Service Oriented Architecture (SOA). Alternatively, the source identifying the consequence may be an instance of a different business process.

Optionally, the description of the metadata associated with the input may include a boolean value representing a positive or a negative consequence of the business process instance. Moreover, the business process instance may include a request, and the consequence of the business process instance may include either an approval or disapproval of the request.

In an embodiment of the invention, metadata associated with the input may include, in addition to data concerning a process consequence, data descriptive of the context at which the input was received. This context may include, for example, the time of receiving the input, identification of the field wherein the input was received, or context of a user responsible for the input entry.

FIG. 4B illustrates an embodiment of the invention which is discussed later in the description.

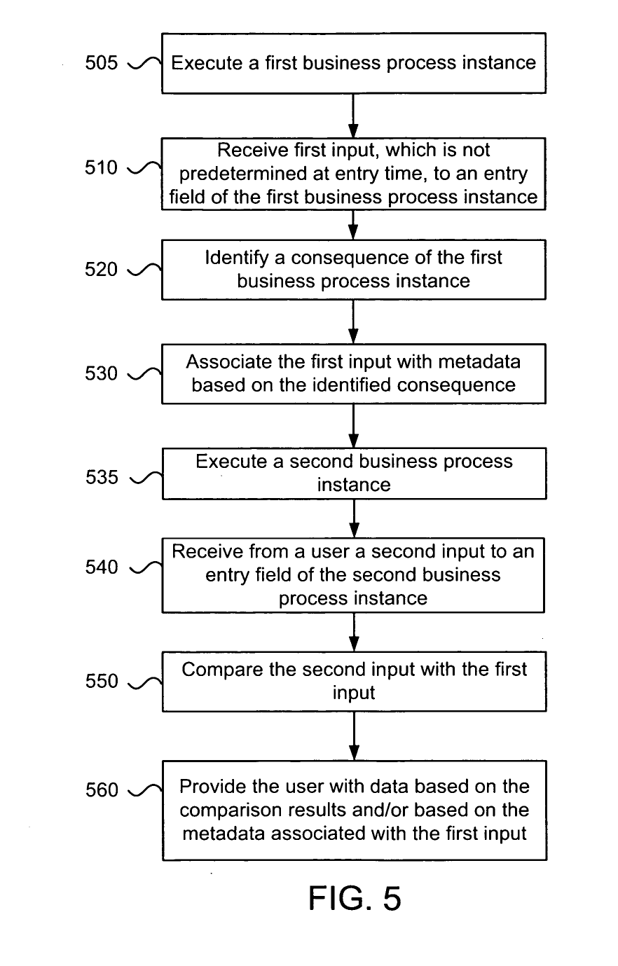

FIG. 5 illustrates an embodiment of the invention. Initially, a first business process instance is executed in step 505. At some point during the execution of the first business process instance, a first input for an entry field of the first business process instance is received in step 510. Subsequently, a consequence of the first business process instance is identified in step 520. The consequence may occur at any point during and/or after the execution of the business process instance. Following these steps, metadata concerning the consequence is generated and associated with the first input in step 530. In step 535, a second business process instance is executed. This may be an instance of the same business process or of a different business process. A second input for an entry field of the second business process instance is received from a user in step 540.

The entry field of the second business process instance may be similar to the entry field of the first business process instance. Furthermore, this similarity may exist even if the two business process instances are instances of two different business processes. In an embodiment of the invention, the aforementioned two business process instances may represent two different processes for contacting business entities. For example, the first process may comprise negotiations with a client and the second process may comprise negotiations with a company representative in the context of inter-enterprise collaboration. Both these processes may have an entry field for requesting a meeting. Inputs to these similar fields may be mutually analyzed with regard to their resulting outcomes. Therefore, it may be possible to provide a user with an input suggestion even though this input was initially received in a similar entry field of a different business process.

In an embodiment of the invention, the first business process instance and the second business process instance may refer to the same business process instance. For example, the entry field of the first business process instance and the entry field of the second business process instance may be similar entry fields at different stages of a single business process instance.

In step 550 the second input that was received from the user is compared with the first input. The comparison may be made, for example, by a function which receives the first and second inputs and generates a comparison result. In an embodiment of the invention, the comparison may be made by a boolean function which indicates inputs as similar if at least one word in one input has a similar word in the other input. A different comparison function may be used which operates upon integer inputs and whose result denotes the proximity of these values to each other. In an embodiment of the invention, the second input is compared with a plurality of previous inputs and the comparison function filters inputs which are irrelevant to the second input. The comparison function may, for example, utilize metadata associated with the plurality of previous inputs. More specifically, the comparison function may compare values from the metadata with context of the second input and/or with predefined values. Context of the second input may comprise context of a user that entered the second input.

It is to be understood that the step of comparing the second input with the first input may include comparing the metadata associated with the second input with the metadata associated with the first input and/or any other action for identifying a possible correlation between the current and stored inputs.

In step 560 the user is provided with data based on results of the comparison and on the metadata associated with the first input. For example, the results of the comparison may denote that the first input is relevant to the input of the user, hence the user may be provided with data describing consequences of the first input.

In an embodiment of the invention, providing the user with data may include providing auto-complete functionality to the entry field of the second business process instance. The auto-complete may suggest inputs which are considered relevant according to metadata associated with those inputs. Furthermore, the auto-complete may provide data extracted from the metadata associated with the inputs. This data may be presented as additional description of the inputs.

The provided data in step 560 may be identical to the first input or be a variation of the first input. The difference between the first input and the provided data may be obtained, for example, by a heuristic algorithm.

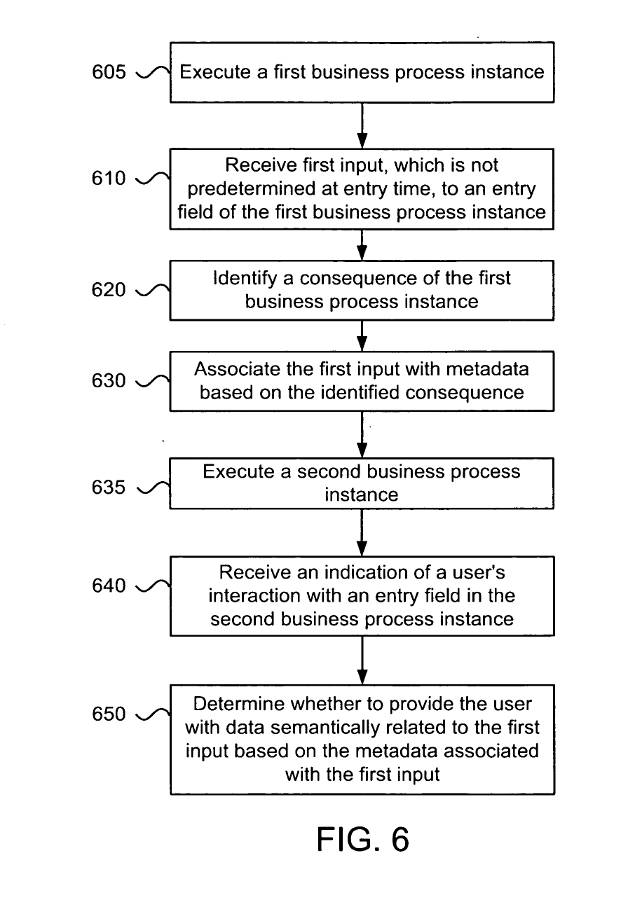

FIG. 6 illustrates an embodiment of the invention. In step 605, a first business process instance is executed. In step 610, which occurs during the execution of the first business process instance, a first input for an entry field of the first business process instance is received. Subsequently, a consequence of the first business process instance is identified in step 620. The consequence may occur at any point during and/or after the execution of the business process instance. Following these steps, in step 630, metadata concerning the consequence is generated and associated with the first input.

In step 635, a second business process instance is executed. An indication of a user's interaction with an entry field of the second business process instance is received in step 640. Without limiting the scope of the invention, in an embodiment of the invention, an indication of a user's interaction with an entry field may include one of the following: user's interaction with a form containing the entry field, user's focus on the entry field, or user's input to the entry field.

Subsequently, in step 650, it is determined whether to provide the user with data semantically related to the first input, e.g. a semantic variation of the first input. The determination is based on the metadata associated with the first input. A determination function may exist, which analyses metadata associated with the first input and optionally data about the context of the user and his interaction with the entry field, and determines whether to provide the user with the data. For example, a determination function may decide whether or not to provide the user with a previous input based on the consequence of the input. In this case, the user is provided only with previous inputs that yielded positive consequences, or variations of such inputs, and the determination function filters out relevant inputs that yielded negative consequences.

Determining whether to provide the user with approximately the first input based on the metadata associated with the first input may be implemented, for example, as follows: assigning each metadata a score and providing the user only with inputs having a score higher than a threshold. Alternatively or additionally, this may be implemented by selecting only metadata that corresponds to the context of the second input or is related to the context of the second input.

In an embodiment of the invention, when providing the user with the data semantically related to the first input, that data may be identical to the first input or be a modification thereof. The provided data may have a meaning equivalent to that of the first input. For example, a thesaurus may be used to identify semantically related data.

Optionally, modified provided data is modified in order to be better adapted to the second business process instance.

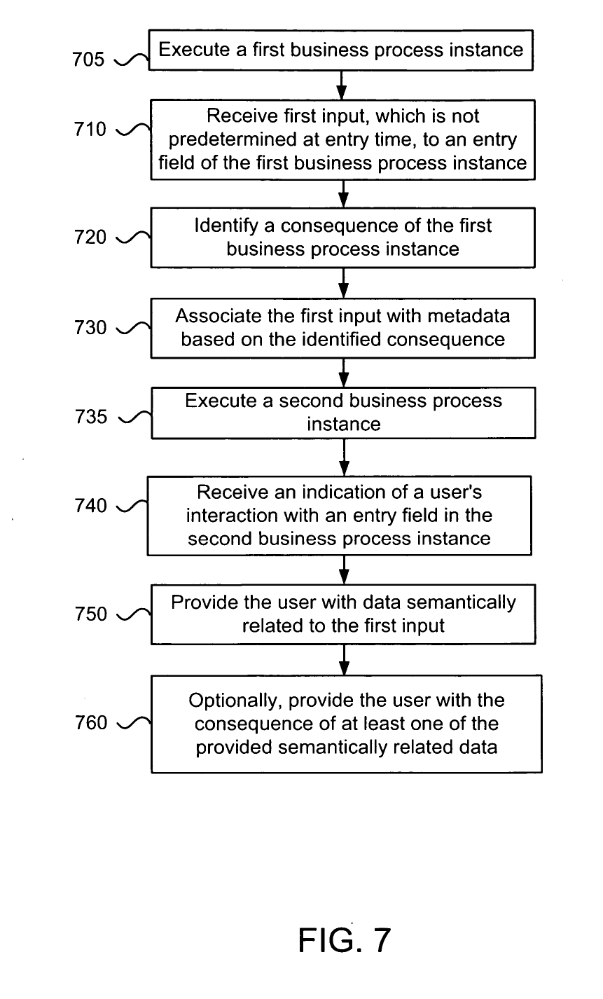

FIG. 7 illustrates an embodiment of the invention. Initially, a first business process instance is executed in step 705. In step 710, during the execution of the first business process instance, a first input for an entry field of the first business process instance is received. Subsequently, a consequence of the first business process instance is identified in step 720. The consequence may occur at any point during and/or after the execution of the business process instance. Following these steps, metadata concerning the consequence is generated and associated with the first input in step 730. In step 735, a second business process instance is executed. In step 740, an indication of a user's interaction with an entry field of the second business process instance is received.

Subsequently, in step 750, the user is provided with data semantically related to the first input, for example, as an auto-complete feature. Optionally, the user may be provided with data based on the metadata associated with the first input, such as a history of previous consequences of entering the first input.

In an embodiment of the invention, the data provided based on the metadata associated with the first input may comprise one or more of the following exemplary options: multiple input suggestions; an icon next to each suggestion, wherein the icon may symbolize a predicted consequence of using the suggested input, wherein the prediction may be based on metadata associated with the inputs; a tool-tip; and/or a pop-up window.

Optionally, in step 760, the user may be provided with data regarding a consequence of a business process instance resulting from at least one of the provided semantically related data. For example, if the user was provided with the first input as an auto-complete suggestion, the user may select it and request data descriptive of a consequence of at least one business process instance resulting from the first input by choosing a corresponding option. Following the request, the user may be provided with the requested data.

In an embodiment of the invention, data provided to the user may be adapted to the user's context. The data may be filtered, modified, complemented with other data, translated, or adapted in any other way. A user's context may be any of the exemplary following: role, project, company, department, expertise, experience with an application, current time, geographical location, preferences, and/or combinations thereof. A detailed discussion about exemplary possible contexts is disclosed below. For example, in an embodiment of the invention, the user may be provided only with data relating to previous inputs entered by users having the same role as the user.

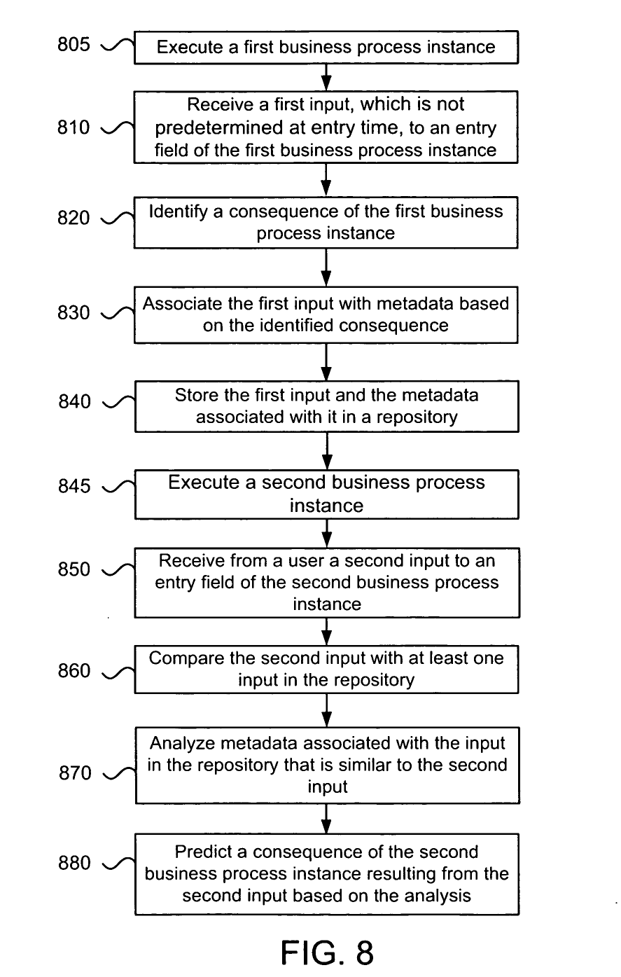

FIG. 8 illustrates an embodiment of the invention. Initially, a first business process instance is executed in step 805. In step 810, during the execution of the first business process instance, a first input for an entry field of the first business process instance is received. Subsequently, a consequence of the first business process instance is identified in step 820. The consequence may occur at any point during and/or after the execution of the business process instance. Following these steps, metadata concerning the consequence is generated and associated with the first input in step 830. The input and the metadata associated with it are then stored in a repository illustrated in step 840. Exemplary structures of such a repository are illustrated by FIGS. 3A-3D.

In an embodiment of the invention, the repository may be directly associated with the entry field of the first business process instance. In an embodiment of the invention, inputs in the repository may be associated with weights according to the intensity of their usage and/or the amount of time that passed since they entered the repository. Thus, specific inputs may be recognized as outdated and/or useless and be automatically removed from the repository.

Optionally, an embodiment of the invention may include the steps disclosed below. A second business process instance is executed in step 845. A second input for an entry field of the second business process instance is received from a user in step 850. In step 860, the second input is compared with relevant inputs stored in the repository. Optionally, the relevant inputs stored in the repository to be compared with are selected based on the context of the input, and/or the field wherein the input was entered. Exemplary methods of comparison are disclosed in the description of FIG. 5. Subsequently, the metadata associated with the input stored in the repository is analyzed in step 870. Optionally, only the metadata that is associated with the input in the repository that is similar to the second input is analyzed.

For example, in an embodiment of the invention, the metadata associated with inputs contained in the repository may comprise statistical data about consequences of those inputs in business process instances, and the metadata is analyzed by averaging the statistical data of inputs which resemble the second input based on the comparison. Based on the analysis, a consequence of the second business process instance that may result from the second input is predicted in step 880.

Optionally, the user may then be provided with the predicted consequence. For example, if inputs in the repository that are similar to the input of the user have had mostly similar consequences, the user may be provided with a prediction that describes the most probable consequence of the user's input.

In an embodiment of the invention, multiple inputs may be received from a user correlating with multiple entry fields. The multiple inputs may be analyzed with respect to each other and an overall prediction of a consequence may be provided to the user. For example, if the repository is used in a medical process, wherein it gathers non-predefined inputs, e.g. prescriptions chosen by a doctor, and their correlation with consequences, e.g. a future diagnosis, a user may receive a prediction of a future diagnosis based on some of the prescriptions chosen by a doctor. Furthermore, if the repository has a mechanism for keeping only up-to-date inputs and their correlating consequences, an environmental change, such as a sudden change in bodily resistance to medications due to a virus, may be quickly incorporated into the consequence prediction mechanism.

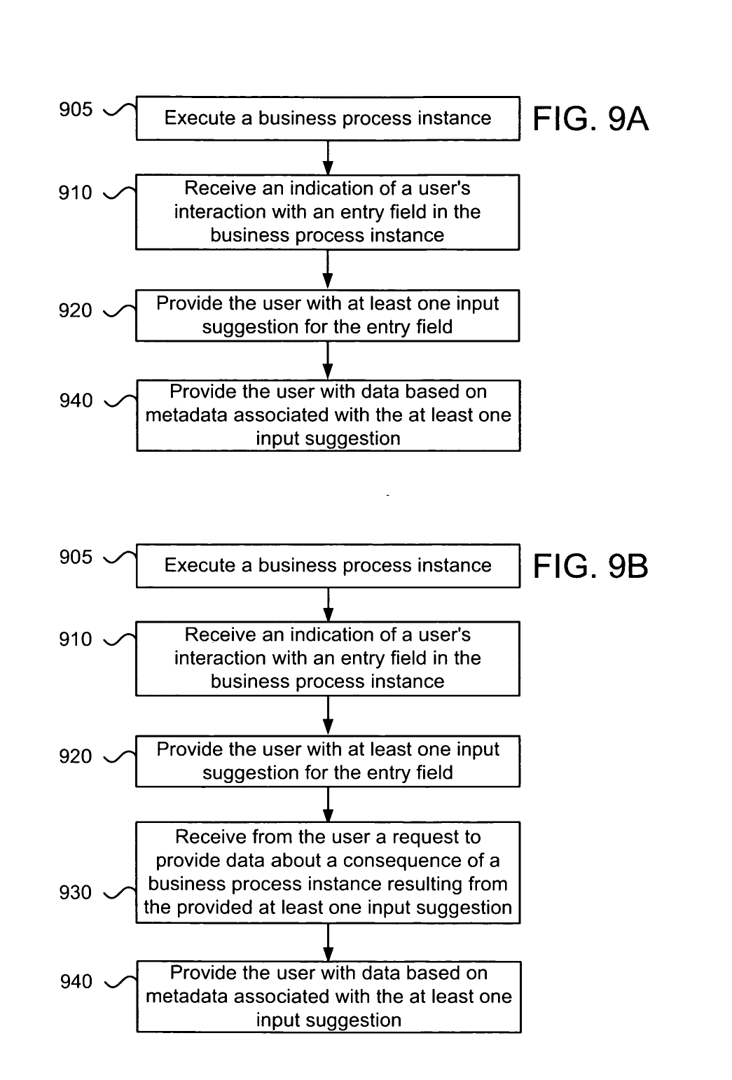

FIGS. 9A-9B are flowcharts illustrating the process steps of providing a user with input suggestions following the user's interaction with an entry field in accordance with an embodiment of the invention.

FIG. 9A illustrates an embodiment of the invention. Initially, a business process instance is executed in step 905. An indication of a user's interaction with an entry field of the business process instance is received in step 910. Following the received indication, the user is provided with input suggestions for the entry field in step 920.

In an embodiment of the invention, the repository and comparison mechanism previously discussed may be used. Subsequently, the user is provided with data based on metadata associated with the input suggestions in step 940.

Referring to FIG. 9B, optionally, prior to the step of providing the user with data in step 940, a request to provide data regarding a consequence of a business process instance resulting from the provided input suggestions may be received from the user in step 930. The data with which the user is provided following the request may be, for example, descriptive of a consequence of at least one business process instance, wherein the description is taken from the metadata associated with the input suggestions.

Optionally, when the user is provided with data based on metadata associated with the input, an icon is displayed next to the provided input. The displayed icon may represent a predicted consequence of using the input, wherein the prediction is based on the metadata.

In an embodiment of the invention, data provided to the user may be adapted to the user's context. The user context may include, for example, one or more of the following: role, project, company, department, expertise, experience with an application, current time, and/or geographical location.

FIG. 4B illustrates another aspect of the invention. In step 450, a business process instance is executed. In step 460, a consequence of the business process instance is identified. The consequence may occur at any point during and/or after the execution of the business process instance. Subsequently, in step 470, a set of inputs to the business process instance which resulted in the consequence are identified. These are inputs which were not predetermined at their entry time, i.e. inputs which required human consideration. An input may be predetermined at entry time, for example, by the context of the business process instance, such as by various related inputs and variables. An input determined by a user's private considerations is not considered predetermined. A predetermined input may be an input whose value must be specific and the only correct possible value at entry time. This value may be received or calculated by a user entering the input. A non-predefined input may be a value provided by a user to an entry field, wherein more than one equally possible values could be provided.

The identified inputs may be all or some of the inputs which caused the consequence and they may have had a direct or an indirect impact on the consequence. Furthermore, these inputs may have come from various sources such as different instances of a business process. Once identified, the inputs are associated with metadata concerning the consequence in step 480.

According to an embodiment of the invention, a consequence of the business process may be one of the following examples: data pertaining to a result of a business process instance, a change in a state of a business process instance, and/or a value received by the system relevant to a business process instance. A consequence may be a triggering event which is associated with some value and/or time. A consequence of a business process may optionally be defined by business logic, policies or rules.

In an embodiment of the invention, at least one input of the set of inputs identified in step 470, or a variation of the input, may be used to auto-complete an entry field in a second business process instance.

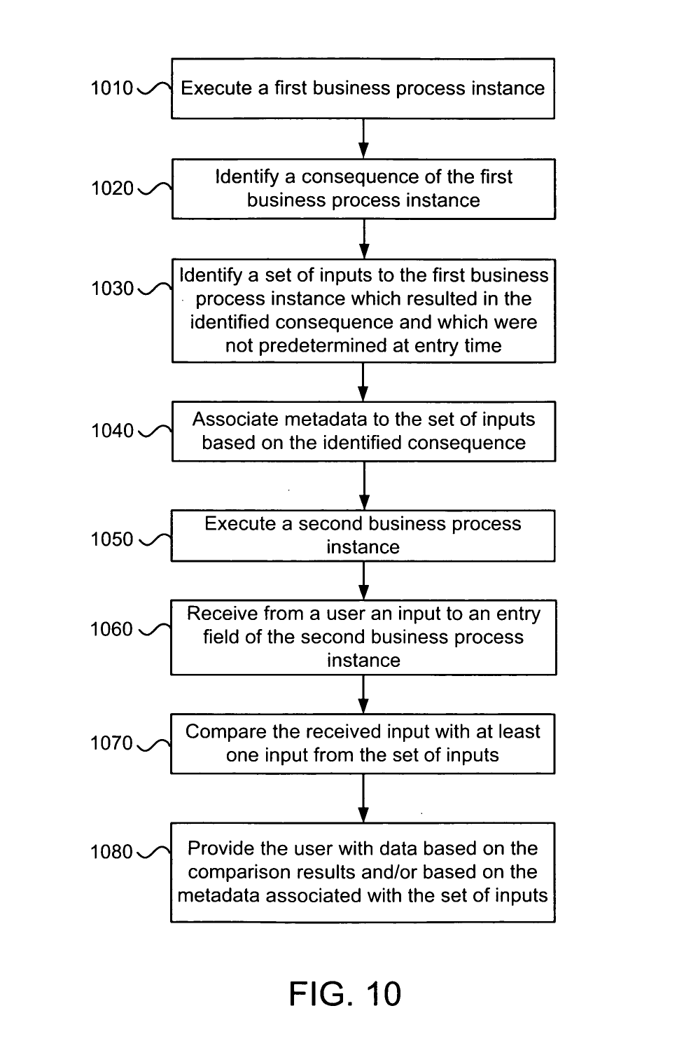

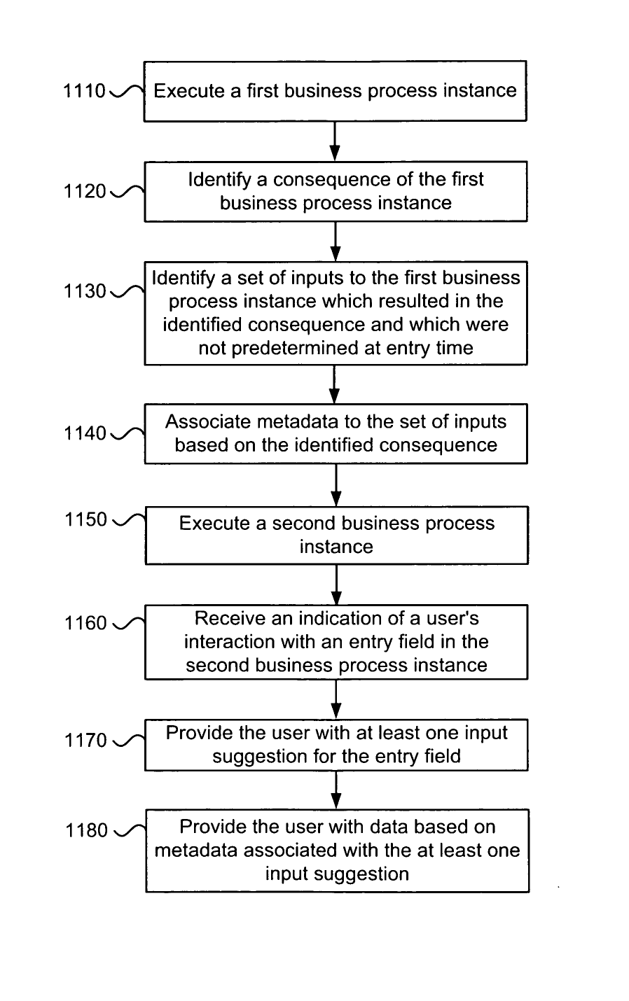

FIG. 10 illustrates another embodiment of the invention. In step 1010, a first business process instance is executed. In step 1020, a consequence of the business process instance is identified. The consequence may occur at any point during and/or after the execution of the business process instance. Subsequently, in step 1030, a set of inputs to the business process instance which resulted in the consequence are identified. These are inputs which were not predetermined at their entry time, i.e. inputs which required human consideration. The identified inputs may be all or some of the inputs which caused the consequence and they may have had a direct or an indirect impact on the consequence. Furthermore, these inputs may have come from various sources such as different instances of a business process. Once identified, the inputs are associated with metadata concerning the consequence in step 1040.

In step 1050, a second business process instance is executed. This may be an instance of the same business process or of a different business process. An input for an entry field of the second business process instance is received from a user in step 1060.

In step 1070, the input that was received from the user is compared with at least one input from the set of inputs that were identified in step 1030. In an embodiment of the invention, the repository and comparison mechanism previously discussed may be used.

In step 1080 the user is provided with data based on results of the comparison and on the metadata associated with the set of inputs. In an embodiment of the invention, the user may be provided with the consequence of the set of inputs. For example, the results of the comparison may denote that an input from the set of inputs is relevant to the input received from the user, hence the user may be provided with data describing the relevant input and a consequence of the set of inputs.

In an embodiment of the invention, providing the user with data may include providing auto-complete functionality to the entry field of the second business process instance. The auto-complete functionality may suggest one or more inputs from the set of inputs or a variation of these inputs.

FIG. 11 illustrates another embodiment of the invention. In step 1110, a first business process instance is executed. In step 1120, a consequence of the business process instance is identified. The consequence may occur at any point during and/or after the execution of the business process instance. Subsequently, in step 1130, a set of inputs to the business process instance which resulted in the consequence are identified. These are inputs which were not predetermined at their entry time, i.e. inputs which required human consideration. The identified inputs may be all or some of the inputs which caused the consequence and they may have had a direct or an indirect impact on the consequence. Furthermore, these inputs may have come from various sources such as different instances of a business process. Once identified, the inputs are associated with metadata concerning the consequence in step 1140.

A second business process instance is executed in step 1150. An indication of a user's interaction with an entry field of the business process instance is received in step 1160. Following the received indication, the user is provided with input suggestions for the entry field in step 1170. At least one of the input suggestions may be an input from the set of inputs identified in step 1130, or a variation of that previously identified input.

In an embodiment of the invention, the repository and comparison mechanism previously discussed may be used. Subsequently, the user is provided with data based on metadata associated with the input suggestions in step 1180. In an embodiment of the invention, the user may be provided with the consequence of the set of inputs.

In an embodiment of the invention, providing the user with data may include providing auto-complete functionality to the entry field of the second business process instance. The auto-complete functionality may suggest one or more inputs from the set of inputs or a variation of these inputs.

Above described embodiments supply the user with input suggestions based on prior business process consequences and optionally further based on context. The following list includes types of contexts, examples of contexts and methods for deriving contexts. The list, or its equivalents, may be used in the embodiments of the present invention.
a) The context may be relevant Business Data, such as, user role, user's current and past projects, other projects of the user's company, user profile, other people in the user's role/ project/ department, user's company and company profile, user level of experience (for example novice, intermediate, expert) with the system, user's level of expertise related to the client selected by the user, meta-data associated with the user, and sources outside the user's environment such as a user's profile on the web.
b) The context may be a physical status of the user, such as, for example, whether the user is hard of hearing, near-sighted or far-sighted. The system may take into account the user's temporary physical or mental status, for example, whether the user is distracted, nervous or tired. The user's temporary physical or mental status may be inferred from a measure of pulse or respiration rate of the user, a skin conductivity of the user, visual and vocal expressions of the user, user speed of activity or frequency of interaction with the device.
c) The context may be the user's current task and the user's goal, which is either an ultimate goal or a sub-goal.
d) The context may be user privileges and authority information.
e) The context may be the amount and type of resources available for the task at hand (for example, the current project's budget).
f) The context may be data from the user's device and application environment, such as active programs in the user's environment, any menus, tabs or other controls selected by the user, documents in the user's environment, user's mailbox, schedule, preferences, available hardware and/or devices, active documents and web-pages, and deriving the context from analyzing the text the user is working on.
g) Contexts may include a variety of types of information about devices within the computing system, such as device types, named users of the devices, device location, device capabilities, interaction methods, software platforms, the amount of free storage on a device, information about devices, data, and applications to which a particular device has access, information about connection bandwidth available to a device, information about network type, the latency to transfer data over a transmission medium and availability of differing network technologies, and information on whether a user has a device.
h) The context may be data about the user's physical environment, such as location, time and environmental conditions, such as temperature, speed, loudness, background noise, lightness or darkness, the weather, or nearby equipment. Such data may be measured by appropriate sensors or otherwise inferred.
i) The context may be the existence and/or identity of nearby users, for example, whether the user is alone or with someone else.
j) The context may be inferred from metadata, such as, user company's connections with other companies and financial data, information about other users that are associated with the user, and data about people related to the user. For example, the system may use information about the groups the user is a member of and about other members of such groups. Such information may be derived, for example, from a user's contact list or from distribution lists of which the user is a member.
k) The context may be history and logs, such as history of user activity, history of user interaction with the system, and history of activity of the system receiving the data. For example, the system may provide information based on the user's most recent accesses to the system or the user's most frequent types of interaction with the system.

The following are examples of context derivation methods from various sources, such as user input, user profile, organizational databases, sensors, status of applications and devices in use:

a) The context may be based upon the user identity or function, wherein predefined contexts are stored for each user or class of users. The user identity may either be defined explicitly by using a user identifier such as log on ID for each user of the system, or implicitly by having a stored set of context definitions for each terminal able to access the system and assuming that the user for each terminal is always the same user or class of users.
b) A context definition may be based on the information requested by the user or the information sent for display in response to a request. Further, where the context definition is based on the information requested, the context definition may be based on either or both of the type of information requested and/or the actual value of the information requested.
c) The context of the application may be deduced from other available information including other user inputs to the application, dialogue between a user desktop and the application, or, where the application is run on a remote server, dialogue between a user terminal and the application, or dialogue between a web browser client and the application server or web server. The context of the application can of course be deduced based on more than one source of available information.

Although the present invention has been described in considerable detail with reference to certain embodiments thereof, other embodiments are possible. Therefore, the spirit and scope of the appended claims should not be limited to the description of the embodiments contained herein.

It is appreciated that certain features of the embodiments, which are, for clarity, described in the context of separate embodiments, may also be provided in various combinations in a single embodiment. Conversely, various features of the embodiments, which are, for brevity, described in the context of a single embodiment, may also be provided separately or in any suitable sub-combination.

It is to be understood that the embodiments are not limited in their applications to the details of the order or sequence of steps of operation or implementation of the methods set forth in the description, drawings, or examples.

Any citation or identification of any reference in this application shall not be construed as an admission that such reference is available as prior art to the embodiments of the present invention.

While the embodiments have been described in conjunction with specific examples thereof, it is to be understood that they have been presented by way of example, and not limitation. Moreover, it is evident that many alternatives, modifications and variations will be apparent to those skilled in the art. Accordingly, it is intended to embrace all such alternatives, modifications and variations that fall within the spirit and broad scope of the appended claims and their equivalents.

Any element in a claim that does not explicitly state “means for” performing a specific function, or “step for” performing a specific function, is not to be interpreted as a “means” or “step” clause as specified in 35 U.S.C. § 112, ¶6.

What is claimed is:

1. A computer-implemented method comprising:
executing a first business process instance;
receiving a first input to an entry field in the first business process instance, wherein the first input is not predetermined at entry time;
identifying a consequence of the first business process instance; and
associating the first input with metadata based on the identified consequence;
wherein the identified consequence of the first business process instance is not predetermined when the first input is received.

2. The method of claim 1, wherein the consequence of the first business process instance comprises a modification of the first input in the entry field.

3. The method of claim 1, wherein the metadata associated with the first input comprises a score of the first input based on the identified consequence.

4. The method of claim 1, wherein the step of identifying the consequence of the first business process instance comprises receiving data from a source other than the first business process instance.

5. The method of claim 1, wherein the metadata associated with the first input comprises a description of the identified consequence.

6. The method of claim 1, wherein the metadata associated with the first input is further based on a context of a user that entered the first input.

7. The method of claim 1, further comprising:
executing a second business process instance;
receiving a second input from a user to an entry field in the second business process instance;
comparing the second input with the first input; and
providing the user with data based on the comparison and based on the metadata associated with the first input.

8. The method of claim 7, wherein the first business process instance and the second business process instance are instances of the same business process and the entry field in the first business process instance is similar to the entry field in the second business process instance.

9. The method of claim 7, wherein the second input resembles the first input; and the user is provided with data about the consequence of the first business process instance that, at least in part, resulted from the first input.

10. The method of claim 7, further comprising the step of auto-completing the second input with the provided data.

11. The method of claim 1, further comprising:
executing a second business process instance;
receiving an indication of a user's interaction with an entry field in the second business process instance; and
determining whether to provide the user with data semantically related to the first input, based on the metadata associated with the first input.

12. The method of claim 1, further comprising:
executing a second business process instance;
receiving an indication of a user's interaction with an entry field in the second business process instance;
providing the user with data semantically related to the first input; and
providing the user with data based on the metadata associated with the first input.

13. The method of claim 12, wherein providing the user with the semantically related data comprises auto-completing the entry field of the second business process instance with the semantically related data.

14. The method of claim 12, further comprising the step of providing the user with the consequence of at least one of the provided semantically related data.

15. The method of claim 12, wherein at least some of the data provided to the user is adapted to the user's context.

16. The method of claim 15, wherein the context comprises at least one of the following: role, project, company, department, expertise, experience with an application, current time, geographical location, or a combination thereof.

17. The method of claim 1, further comprising:
storing the first input and the metadata associated with the first input in a repository, wherein the repository is capable of containing multiple inputs, metadata and associations between the inputs and the metadata.

18. The method of claim 17, further comprising:
executing a second business process instance;
receiving a second input from a user to an entry field in the second business process instance;
comparing the second input with at least one input stored in the repository;
analyzing metadata associated with an input stored in the repository that is similar to the second input; and
predicting a consequence of the second business process instance resulting from the second input based on the analysis.

19. The method of claim 18, further comprising:
providing the user with the predicted consequence of the second business process instance.

20. A computer-implemented method comprising:
executing a business process instance;
receiving an indication of a user's interaction with an entry field in the business process instance;
providing the user with at least one input suggestion for the entry field; and
providing the user with data based on metadata associated with the at least one input suggestion;
wherein the at least one input suggestion is a previously entered input, and the metadata associated with the at least one input suggestion is based on a consequence of a business process instance wherein the input was used.

21. The method of claim 20, wherein the step of providing the user with the data based on the metadata is triggered by an appropriate user request.

22. The method of claim 20, wherein providing the user with at least one input suggestion comprises auto-completing the entry field in the business process instance with the at least one input suggestion.

23. The method of claim 20, wherein the provided at least one input suggestion is adapted to the user's context.

24. A computer-implemented method comprising:
executing a first business process instance;
identifying a consequence of the first business process instance;
identifying a set of inputs to the first business process instance which resulted in the identified consequence and which were not predetermined at entry time; and
associating metadata with the set of inputs based on the identified consequence;
wherein the consequence was not determined prior to receiving the set of inputs to the first business process instance.

25. The method of claim 24, further comprising:
executing a second business process instance;
receiving an input from a user to an entry field in the second business process instance;
comparing the received input with at least one input from the set of inputs; and
providing the user with data based on the comparison and based on the metadata associated with the set of inputs.

26. The method of claim 25, wherein providing the user with data comprises auto-completing the entry field with at least one input from the set of inputs.

27. The method of claim 25, further comprising the step of providing the user with the consequence of a previously entered input that is similar to the input received from the user.

28. The method of claim 24, further comprising:
executing a second business process instance;
receiving an indication of a user's interaction with an entry field in the second business process instance;
providing the user with at least one input suggestion for the entry field; and
providing the user with data based on metadata associated with the at least one input suggestion, wherein at least one of the input suggestions is derived from the set of inputs.

29. The method of claim 28, wherein providing the user with at least one input suggestion comprises auto-completing the entry field in the business process instance with the at least one input suggestion.

30. The method of claim 28, wherein the step of providing the user with data comprises providing the user with the consequence of the set of inputs.

31. The method of claim 24, further comprising:
using at least one input of the set of inputs to auto-complete an entry field in a second business process instance.
